(19) United States
(12) Patent Application Publication
(10) Pub. No.: US 2022/0282179 A1
(43) Pub. Date: Sep. 8, 2022

(54) Electro-Rheological Fluid Composition and Cylinder Device

(71) Applicant: HITACHI ASTEMO, LTD., Hitachinaka-shi, Ibaraki (JP)

(72) Inventor: Satoshi ISHII, Tokyo (JP)

(21) Appl. No.: 17/627,168

(22) PCT Filed: Jul. 13, 2020
(86) PCT No.: PCT/JP2020/027192

§ 371 Date: Jan. 14, 2022

(30) Foreign Application Priority Data
Jul. 24, 2019 (JP) 2019-136007

(51) Int. Cl. C10M 171/00; C10M 171/06; C10M 149/14; F16F 9/46; F16F 9/53; F16F 9/32

(52) U.S. Cl. CPC C10M 171/001; C10M 171/06; C10M 149/14; F16F 9/46; F16F 9/532; F16F 9/3207; C10M 2217/045; C10N 2020/06

(57) ABSTRACT

A task of the present invention is to provide an electro-rheological fluid composition and a cylinder device which allow a large ER effect to be obtained, while reducing a current density. An electro-rheological fluid composition (8) of the present invention includes a fluid (32) and a particle (28) having an ion conductivity, the particle (28) having the ion conductivity has a first layer (29) forming a surface of the particle (28) and a second layer (30) forming a part of the particle (28) interior to the first layer (29), and an ion conductivity of the first layer (29) is lower than an ion conductivity of the second layer (30).

### TECHNICAL FIELD

The present invention relates to an electro-rheological fluid composition and a cylinder device.

### BACKGROUND ART

In general, in a vehicle, a cylinder device is mounted to damp vibration during driving in a short period of time and improve ride comfort and driving stability. As such a cylinder device, a shock absorber using an electro-rheological fluid (electro-rheological fluid composition, ERF) to control a damping force based on a road surface state or the like is known. In the cylinder device mentioned above, an ERF including particles (ERF of a particle dispersion system) is typically used, and it is known that a material and a structure of each of the particles affect performance of the ERF, and consequently affect performance of the cylinder device.

Patent Literature 1 discloses a method of producing powder for electro-rheological fluid, which is characterized by performing a first treatment step of treating organic semiconductor particles with an alkaline solution at pH 7.2 to 7.8 to adjust an electric conductivity to 1×10⁻⁸ to 5×10⁻¹⁰ S/cm and a second treatment step of treating the organic semiconductor particles after the first treatment step with an alkaline solution at pH 7.9 to 9.0 to adjust the electric conductivity to 1×10⁻⁹ to 3×10⁻¹¹ S/cm.

### CITATION LIST

### Patent Literature

Patent Literature 1: Japanese Unexamined Patent Application Publication No. Hei 6(1994)-220419

### SUMMARY OF INVENTION

### Technical Problem

In a case of the ERF of the particle dispersion system described above, when the electric conductivity is low, an ER effect (yield stress) is insufficient while, when the electric conductivity is excessively high, a current density excessively increases, and the device may be abnormally overheated. In other words, the ER effect (yield stress) and the current density have a tradeoff relationship therebetween, and it is one of tasks to satisfy both of the ER effect and the current density.

In the powder for electro-rheological fluid having a double-layered structure having the different electric conductivities described in Patent Literature 1 mentioned above, the electric conductivity at a surface of the powder is low, and accordingly a short-circuit or the like is prevented and a current is reduced, resulting in a reduced current density. Meanwhile, the electric conductivity is sufficiently high in the powder, and therefore it is assumed that charge movement in the particle is high, the high yield stress is obtained, and responsiveness (a time period from when a voltage is applied until a viscosity changes) is also sufficiently high. However, in a configuration of the electro-rheological fluid described in Patent Literature 1, carriers for electric conduction are electrons and accordingly, to obtain a larger ER effect (yield stress), it is required to increase the electrons included in the particle to contribute to polarization of the particle. In this case, since it is difficult to increase a density of the electrons without changing a basic material composition, it is required to supply a larger number of electrons from the outside and increase an electric conductivity difference between the inside and the outside of the particle, and it is inevitable to improve the specifications of a power source for applying a higher voltage, increase the current density, and drastically change a material. As a result, it has been desired to develop an ERF of a different system which drastically solve the problem described above.

In view of the circumstances described above, the present invention is intended to provide an electro-rheological fluid composition and a cylinder device using the same which allow a large ER effect (yield stress) to be obtained, while reducing a current density.

### Solution to Problem

An aspect of the present invention which attains the object described above is an electro-rheological fluid composition including: a fluid; and a particle having an ion conductivity. The particle having the ion conductivity has a first layer forming a surface of the particle and a second layer forming a part of the particle interior to the first layer, and an ion conductivity of the first layer is lower than an ion conductivity of the second layer.

Another aspect of the present invention is a cylinder device including: an inner cylinder; a piston movable along the inner cylinder; an electro-rheological fluid composition filling a space between the inner cylinder and the piston; and a voltage application device that applies a voltage to the electro-rheological fluid composition, and the electro-rheological fluid composition is the electro-rheological fluid composition in the present invention described above.

### Advantageous Effect of Invention

According to the present invention, it is possible to provide an electro-rheological fluid composition and a cylinder device using the same which allow a large ER effect (yield stress) to be obtained, while reducing a current density.

Problems, configurations, and effects other than those described above will be made apparent by the following description of an embodiment.

### BRIEF DESCRIPTION OF DRAWINGS

FIG. 1 is a schematic diagram illustrating an example of an ERF composition in the present invention;

FIG. 2 is a schematic vertical cross-sectional view illustrating an example of a cylinder device in the present invention;

FIG. 3 is a graph comparatively illustrating respective yield stresses in Examples 1 to 3 and Comparative Example 1;

FIG. 4 is a graph comparatively illustrating respective current densities in Examples 1 to 3 and Comparative Example 1;

FIG. 5 is a graph comparatively illustrating respective yield stresses in Examples 4 to 7 and Comparative Examples 2 and 3;

FIG. 6 is a graph comparatively illustrating respective current densities in Examples 4 to 7 and Comparative Examples 2 and 3;

FIG. 7 is a graph comparatively illustrating respective yield stresses in Examples 7, 8, and 11 and Comparative Examples 4 and 5;

FIG. 8 is a graph comparatively illustrating respective current densities in Examples 7, 8, and 11 and Comparative Examples 4 and 5;

FIG. 9 is a graph illustrating relations among a ratio of a hardening agent added for a first layer to all hardening agents, a yield stress in the first layer, and a current density in the first layer; and

FIG. 10 is a graph illustrating relations among the ratio of the hardening agent added for the first layer to all the hardening agents and change rates of the yield stress and the current density in the first layer.

### DESCRIPTION OF EMBODIMENTS

Referring to the drawings, a description will be given below of an embodiment of the present invention.

[ERF Composition]

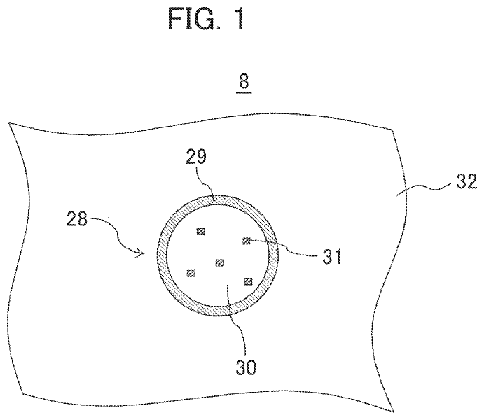

FIG. 1 is a schematic diagram illustrating an example of an ERF composition in the present invention. As illustrated in FIG. 1, an ERF composition 8 in the present invention includes a fluid 32 and particles 28 each having an ion conductivity. The fluid 32 is a dispersion medium made of a medium (base oil) having an insulating property, and the particles 28 are a dispersion phase dispersed in the base oil. In other words, a suspension liquid in which the particles 28 are dispersed in the fluid 32 is the ERF composition 8. Each of the particles 28 having the ion conductivity is a material which exhibits an ER effect of increasing a viscosity of the ERF composition 8 with an application of a voltage. Hereinafter, the “ERF composition 8” will be referred to as the “ERF 8”, and “each of the particles 28 having the ion conductivity” will be referred to as the “ERF particle 28” or also as the “particle 28”.

For the ERF particle 28, a particle which has an excellent ER effect and allows a current density to be held low is used. As illustrated in FIG. 1, the particle 28 has a first layer 29 forming a surface of the particle 28 and a second layer 30 forming a part of the particle 28 interior to the first layer 29. The second layer 30 includes an electrolytic material (ions) 31. An ion conductivity of the first layer 29 is set lower than an ion conductivity of the second layer 30. In other words, the ER effect of the particle 28 is achieved mainly by the second layer 30 inside the particle 28.

As described above, the particle 28 in the present invention has the ion conductivity, not an electric conductivity. Accordingly, when the ERF composition is produced, the particle 28 has a larger number of ions included therein to be able to achieve the excellent ER effect, instead of increasing a current density with a supply of electrons from the outside. In addition, by adjusting a quantity of the ions, it is possible to obtain an intended ER effect. Moreover, since the second layer 30 including the ions 31 is covered with the first layer 29, it is possible to confine the ions 31 in the particle 28 and efficiently use the ions to achieve the ER effect (yield stress) without using the ions as carriers in a current and improve the ER effect. Therefore, it is possible to obtain the ERF composition that allows a large ER effect (yield stress) to be obtained, while reducing the current density.

The ion conductivities of the first layer 29 and the second layer 30 can be measured using atomic force microscopy (AFM). It is also possible to identify chemical compositions of the first layer 29 and the second layer 30 by using a Fourier transform infrared spectrometer (FT-IR), a Raman spectrometric method, or the like and evaluate a difference between the first layer and the second layer. It is also possible to measure ion conductivities of bulk bodies having the identified chemical compositions by an impedance method.

Note that the particle 28 may also be configured to have three or more layers. It may also be possible that there are no definite boundaries between these layers. When the layer forming an outermost side of the particles 28 is lower in ion conductivity than the layers forming a part interior to the layer, the effect of the present invention is achieved. The following will describe a configuration of each of the particles 28 in detail.

(1) First Layer and Second Layer

Materials of the first layer and the second layer each included in the particle 28 are not particularly limited as long as the materials can provide the ion conductivities, but the following organic materials and inorganic materials are preferred. Examples of the preferred organic materials include organic particles of a methacrylic resin represented by polymethyl methacrylate, an acrylic resin, a polyurethane resin, a phenol resin, an epoxy resin, an oxetane resin, a carbonate resin, an ion exchange resin, high-density polyethylene, high-density polypropylene, polyimide, and polyamide. Examples of the inorganic materials, particularly the material forming the first layer, include a metal oxide, such as an oxide of silica, titania, zirconia, or lanthanum, and a metal sulfide.

Alternatively, a composite particle obtained by coating a particle made of an organic material with another organic material or an inorganic material such as a metal oxide or the like can also be used for the present invention. The particle 28 may also be in the form of a hollow particle or a particle of a porous material.

In the case of the ERF particle 28 including the polyurethane resin, a monomer shown below can be used. Examples of a material that can be used as a polyol component serving as a main component of the polyurethane resin include polyether-based polyol, polyester-based polyol, polycarbonate-based polyol, vegetable-oil-based polyol, and castor-oil-based polyol. However, the polyol component is not limited to those shown above, and any polyol having a plurality of hydroxyl groups can be used.

A representative material of a hardening agent for the polyurethane resin is isocyanate. In particular, diisocyanate having two isocyanate groups in a molecule thereof is used in most cases, and diisocynates are roughly categorized into diisocyanate having an aliphatic skeleton and diisocyanate having an aromatic skeleton. Examples of the diisocyanate having the aliphatic skeleton include hexamethylene diisocyanate (HDI), isophorone diisocyanate (IPDI), hydrogenated xylylene diisocyanate, and dicyclohexylmethane diisocyanate.

Examples of the diisocyanate having the aromatic skeleton include toluene diisocyanate (TDI), diphenylmethane diisocyanate (MDI), polymeric MDI (pMDI), tolidine diisocyanate, naphthalene diisocyanate (NDI), xylylene diisocianate (XDI), tetramethyl-m-xylylene diisocyanate, and dimethylbiphenyl diisocyanate (BPDI).

Note that adduct, isocyanurate, biuret, uretdione, blocked isocyanate, and the like corresponding to modified isocyanates can also be used. The modified isocyanates include TDI types, MDI types, HDI types and IPDI types. The individual types have individual modified products, and any of the modified products can be used.

It is also possible to use a plurality of types of the isocyanates mentioned above in combinations. For example, it is possible to use a hardening agent mixture of TDI and BPDI to cure the first layer 29 and use TDI to cure the second layer 30. It is also possible to additionally use indirect materials (such as a chain extender and a cross-linker) and modify polyurethane. For example, as the indirect materials, diol, diamine, polyalcohol, and the like are used. Examples of the diol include 1,3-propanediol, 1,4-buthanediol, 1,6-hexanediol, neopentyl glycol, and 1,4-cyclohexanedimethanol. Examples of the diamine include dimethylthio toluene diamine, 4,4-methylenebis-o-chloroaniline, isophorone diamine, and ethylene diamine. Examples of the polyalcohol include 1,1,1-trimethyl propane and glycerin.

Note that, even polyurethane formed of a material other than the materials mentioned above falls within the scope of the present invention as long as the ion conductivity of the first layer 29 is lower than the ion conductivity of the second layer 30.

By selecting the hardening agents to be used to produce the first layer and second layer such that the ion conductivity of the first layer 29 is lower than the ion conductivity of the second layer 30, it is possible to obtain the particle 28 in which the ion conductivity of the first layer 29 is lower than the ion conductivity of the second layer 30.

As the materials forming the first layer 29 and the second layer 30, an epoxy resin and an oxetane resin, each of which is a heterocyclic compound including oxygen, can also be used. Examples of a main component used when the epoxy resin is produced include a bisphenol A type, a bisphenol F type, urethane-modified epoxy, rubber-modified epoxy, chelate-modified epoxy, novolac type epoxy, cyclic aliphatic type epoxy, long-chain aliphatic type epoxy, glycidyl ester type epoxy, and glycidyl amine time epoxy. Examples of a hardening agent used when the epoxy resin is produced include an amine type hardening agent, an acid anhydride type hardening agent, and a polyamide type hardening agent.

The epoxy resin and the oxetane resin react with a phenol resin in the presence of an onium salt to form a phenol/epoxy composite material. Examples of ions generated from the onium salt include ammonium cations, phosphonium cations, oxonium cations, sulfonium cations, fluoronium cations, chloronium cations, iminium cations, diazonium cations, nitronium cations, and hydrazinium cations. In addition to forming a particle of a composite material with the phenol resin, reacting epoxy or oxetane with a surface of a phenol resin particle also allows the surface to be compounded.

As each of the materials forming the first layer 29 and the second layer 30, a phenol resin can also be used. Examples of a phenol compound are not particularly limited, and include ethylphenol, propylphenol, n-butylphenol, tert-butylphenol, octylphenol, allylphenol, dipropylphenol, and dibutylphenol. These phenol compounds can be used alone or in combination of two or more.

The ion conductivity of an organic material is closely related to a mobility of polymer chains, and it is known that, as molecular chains are easier to move, the ion conductivity is higher. As an index indicating a mobility of the molecular chains, there is a glass transition temperature (T_{g}), and the higher T_{g} indicates slower movement of the molecular chains. In other words, the higher T_{g} is synonymous to the lower ion conductivity. Accordingly, by setting T_{g} of the first layer 29 higher than T_{g} of the second layer 30, it is possible to obtain the effect of the present invention.

In the present invention, the ions 31 are sealed in each of the particles 28, and polarization is caused in the particle by a voltage to arrange the ER particles and thereby cause the ER effect. When the ions 31 do not stay in the particles 28 and leak out, the polarization of each of the particles 28 decreases to result in weak arrangement of the ER particles, or a higher voltage is required to provide the same arrangement. Therefore, it is important to seal the ions 31 in the particles 28.

As described above, Patent Literature 1 discloses the technology of providing an electronic conductivity gradient between the inside of each of the particles 28 and the surface thereof. However, since the technology gives no consideration to movement of ions, even if the ions are allowed to enter the particle, the ions cannot sufficiently be sealed in the particle 28. Meanwhile, in the oxidation treatment performed in Patent Literature 2, a cross-linked structure that significantly affects physical properties of the particles does not basically change, and consequently there is no change in the mobility of the molecular chains, and an effect of limiting the movement of the ions cannot be obtained. In addition, the conductivity in a higher conductivity portion of the ERF in the present invention is equal to a value of that (Higher Conductivity Portion: 1×10⁻⁸ to 5×10⁻¹⁰ S/cm) shown in Patent Literature 1, but the conductivity in a lower conductivity portion of the ERF in the present invention is lower than a value of that (Lower Conductivity Portion: 1×10⁻⁹ to 3×10⁻¹¹ S/cm) shown in Patent Literature 1. In other words, each of the particles in the present invention has a difference between an inner layer (the higher conductivity portion) and an outer layer (the lower conductivity portion) as compared with the particles described in Patent Literature 1. This means that, in each of the particles in the present invention, the inner and outer layers are allowed to have more remarkably isolated functions than those of the inner and outer layers in each of the particles in the known example, i.e., a further reduction is successfully achieved in current density (ion conduction), while an equal ER effect is achieved. The effect in the present invention in which the remarkable isolation is successfully achieved between the respective functions of the inner and outer layers is more excellent than the effect achieved by the particle described in Patent Literature 1. In other words, the concept of the present invention that the ions are sealed in the particle is technically more difficult than the concept in Patent Literature 2, and therefore it can be considered that the effect of the present invention cannot be obtained from the technology in the known example. In the present invention, it is possible to obtain the ER particle in which the ions can be sealed only by sufficiently reducing the ion conductivity at the surface of the particle.

(2) Production Method of ERF Particles

Examples of a chemical method serving as a production method of the particles 28 each having the configuration described above include a suspension polymerization method, a miniemulsion polymerization method, a soap-free polymerization method, a dispersion polymerization method, an interfacial polycondensation method, a seed polymerization method, and a sol-gel method. Meanwhile, examples of a physical method serving as the production method include a drying-in-liquid method, a coacervation method, a hetero-coagulation method, a phase separation method, and a spray drying method. These methods allow each of the particles to be encapsulated (a configuration in which the first layer 29 is formed on the surface of the second layer 30 to be produced).

Besides these methods, surface modification based on formation, on surfaces of the organic material particles, a different material by graft polymerization or a metal oxide (such as silica or titania) by the sol-gel method or the like may also be used.

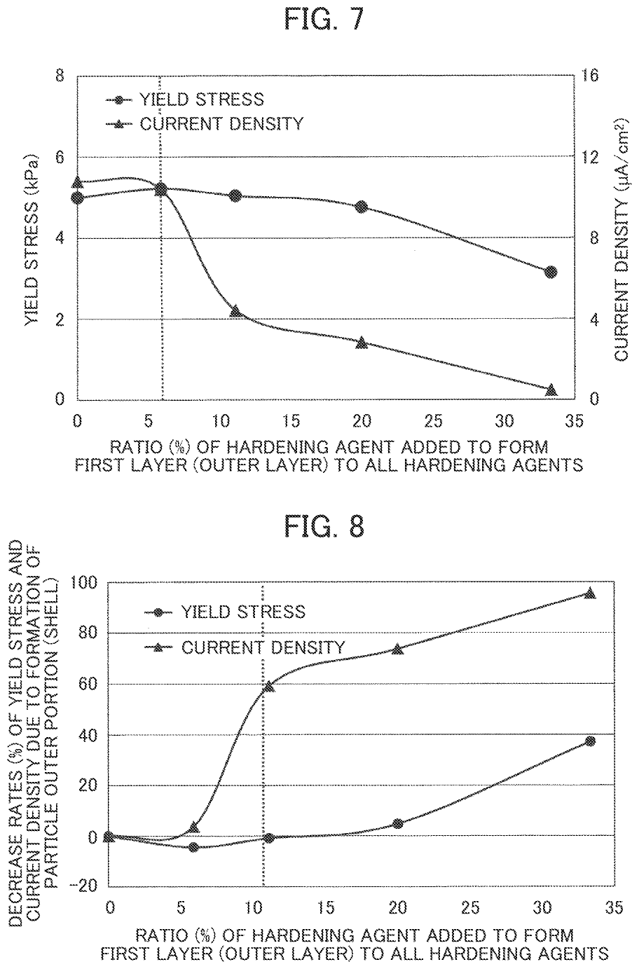

It is assumed that a total amount of a hardening agent forming the first layer and a hardening agent forming the second layer, which are chosen such that the ion conductivity of the first layer is lower than the ion conductivity of the second layer, i.e., a sum total of the hardening agents required to produce the ERF in the present invention is a total addition amount. Preferably, a ratio of an amount of the hardening agent added for the first layer to the total addition amount of the hardening agents is 5.9 mol % or more (the ratio of the additive in the second layer is less than 94.1 mol %). When the ratio of the amount of the hardening agent added for the first layer is less than 5.9 mol %, the effect of the first layer (confining the ions in the particle and improving the efficiency of the ER effect) cannot sufficiently be obtained. In addition, by setting the ratio of the amount of the hardening agent added for the first layer to 5.9 mol % or more, it is possible to reduce the current density, while improving the yield stress of the ERF, as will be described later with reference to FIGS. 7 and 8.

When the ratio of the hardening agent added for the first layer is excessive, it can be considered that the hardening agent used to configure the first layer affects the second layer (inner layer) and reduces the ion conductivity of the second layer. Accordingly, the yield stress has a local maximum value with respect to the ratio of the hardening agent added for the first layer and, when the ratio of the hardening agent added for the first layer is 33.3 mol % or less, the yield stress is higher than that of a particle not having a layered structure but, when the ratio of the hardening agent added for the first layer is 33.3 mol % or more, an yield stress improvement due to a double-layered configuration is no longer observed. Therefore, more preferably, the ratio of the hardening agent added for the first layer is 33.3 mol % or less. However, even when the ratio of the hardening agent added for the first layer is equal to or higher than 33.3 mol %, the current density is significantly reduced to successfully dissolve the trade-off relationship between the yield stress and the current density and satisfy both of the yield stress and the current density, and accordingly the ratio of the hardening agent added for the first layer which is 33.3 mol % or more falls within the scope of the present invention.

(3) Ions Included in ERF Particles

Types of the ions included in the particles 28 are not particularly limited as long as the ions can be disposed in the particles 28 described above and achieve the ER effect (yield stress), but cations preferably include at least one or more types of alkali metals. In particular, lithium ions and potassium ions having small ion radii are more preferably included. As the ion radii are smaller, displacement responsiveness when the voltage is applied is higher. Alkali earth metal ions and transient metal ions, particularly zinc ions, barium ions, magnesium ions, and the like, which are more likely to be coordinated into the molecular chains and stay therein in the inner layers of the particles, are preferred.

As for an addition rate thereof, the effect of the present invention can be expected from any addition rate, and therefore the present invention is not limited by the addition rate. However, in tams of obtaining the sufficient ER effect without excessively increasing the current density (satisfying both of the properties), the addition rate of the metal cations included in an electrolyte is preferably about 1 ppm to 300 ppm.

Anions are also not limited, and acetate ions, sulfate ions, nitrate ions, phosphate ions, halogen ions, and the like can be used. In teams of easy disassociation, the halogen ions are particularly preferred. When corrosion resistance of a wetted part is low, organic anions having low corrosion resistance are preferably used. However, any material applicable to the present invention can be included in the particles, and ions are not limited to those mentioned above as long as the ions can function as the ERF.

When consideration is given to responsiveness of an electro-rhetological effect and a magnitude of the effect, an average particle diameter of the particles 28 is preferably at least 0.1 μm and not more than 10 μm in tams of high mobility of the particles and a viscosity increase. When the average particle diameter is less than 0.1 μm, the particles 28 are aggregated to degrade production workability. In addition, it becomes difficult to produce the particles (particles each having the double-layered configuration including the first layer and the second layer) in the present invention described above. When the average particle diameter is larger than 10 μm, the displacement responsiveness decreases. The average particle diameter of the particles 28 is more preferably in a range of at least 3 μm and not more than 7 μm.

A density of the particles 28 included in the fluid 32 described later is preferably at least 30 mass % and not more than 70 mass % in teams of the magnitude of the ER effect (yield stress) and a base viscosity. When the density of the particles 28 is lower than 30 mass %, the sufficient ER effect (yield stress) can no longer be obtained. When the density of the particles 28 is higher than 70 mass %, a more preferable density for allowing the ER effect (yield stress) to be achieved is in a range of at least 40 mass % and not more than 60 mass %.

(4) Fluid

A type of the fluid 32 is not particularly limited as long as the fluid 32 is an insulating dispersion medium in which the particles 28 can be dispersed. Specifically, silicone oil and mineral oil such as paraffin oil or naphthene oil can be used. Note that, since a viscosity of the fluid 32 contributes to the viscosity and displacement responsiveness of the ERF composition 8, the viscosity of the fluid 32 is preferably 50 mm²/s or less, or more preferably 10 mm²/s or less.

(5) Amount of Moisture Content

An amount of moisture contained in each of the particles 28 is not particularly limited, but is preferably 1000 ppm or less, or more preferably 500 ppm in terms of the magnitude and stability of the electro-rheological effect. Note that there is the ERF using moisture absorbing powder such as cellulose, starch, or silica gel, which is described in Patent Literature 2. However, these are materials that exhibit sufficient electro-rheological effects only by containing several percent of water, and are basically different from the present invention which achieves the electro-rheological effect even when substantially no moisture is contained therein. The ERF that depends on moisture for the achievement of the ER effect has a high sensitivity to an amount of moisture, and consequently lacks stability of the ER effect. Therefore, the present invention that can achieve the ER effect without depending on moisture is an excellent ERF which is preferable for practical use.

[Cylinder Device]

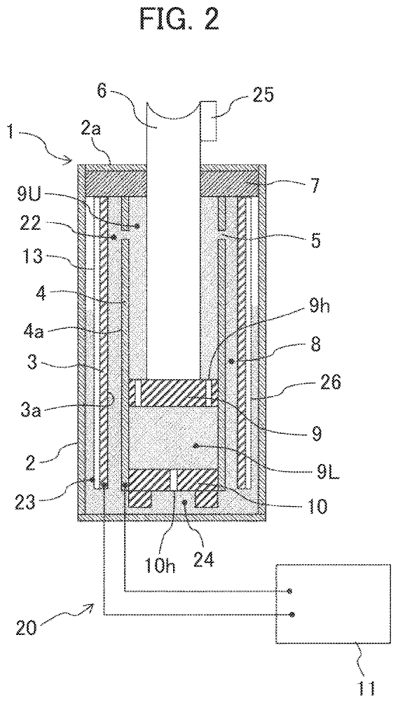

Next, a description will be given of a cylinder device in the present invention. FIG. 2 is a schematic vertical cross-sectional view illustrating an example of the cylinder device in the present invention. A cylinder device 1 is typically provided to correspond to each of wheels of a vehicle on a one-to-one basis to reduce impact/vibration between body axles of the vehicle. In the cylinder device 1 illustrated in FIG. 1, a head provided on one end of a rod 6 is fixed to a body side of the vehicle (not shown), while another end of the rod 6 is inserted into a base shell 2 and fixed to an axle side. The base shell 2 is a cylindrical member forming an outline of the cylinder device 1 and, in the base shell 2, the ERF composition 8 described above is enclosed.

The cylinder device 1 includes, as main components, a piston 9 provided on an end portion of the rod 6, an outer cylinder 3, an inner cylinder (cylinder) 4, and a voltage application device 20 in addition to the rod 6. The rod 6, the inner cylinder 4, the outer cylinder 3, and the base shell 2 are disposed on the same concentric axis.

As illustrated in FIG. 1, the rod 6 has the piston 9 provided on the end portion thereof to be inserted into the base shell 2. The voltage application device 20 includes an electrode (outer electrode 3a) provided on an inner peripheral surface of the outer cylinder 3, an electrode (inner electrode 4a) provided on an outer peripheral surface of the inner cylinder 4, and a control device 11 that applies a voltage between the outer electrode 3a and the inner electrode 4a.

The outer electrode 3a and the inner electrode 4a come into direct contact with the ERF 8. Accordingly, as materials of the outer electrode 3a and the inner electrode 4a, materials resistant to electric erosion and corrosion due to the components included in the ERF 8 mentioned above are preferably used. As the materials of the outer electrode 3a and the inner electrode 4a, steel pipes or the like can also be used but, preferably, stainless pipes, titanium pipes, or the like can be used. Besides, materials obtained by forming a coating of metal resistant to corrosion on a surface of metal susceptible to corrosion by plating, resin layer formation, or the like may also be used.

The rod 6 extends through an upper end plate 2a of the inner cylinder 4, and the piston 9 provided on a lower end of the rod 6 is disposed in the inner cylinder 4. On the upper end plate 2a of the base shell 2, an oil seal 7 is disposed to prevent leakage of the ERF 8 enclosed in the inner cylinder 4.

As a material of the oil seal 7, a rubber material such as, e.g., nitrile rubber or fluorine rubber can be used. The oil seal 7 comes into direct contact with the ERF 8. Accordingly, as the material of the oil seal 7, a material having a hardness equal to or higher than a hardness of the particles included in the ERF 8 is preferably used to prevent the included particles 28 from damaging the oil seal 7. In other words, for the particles 28 to be included in the ERF 8, a material having a hardness equal to or lower than the hardness of the oil seal 7 is used preferably.

Into the inner cylinder 4, the piston 9 is inserted to be slidable in a vertical direction to divide an inner part of the inner cylinder 4 into a piston lower chamber 9L and a piston upper chamber 9U. In the piston 9, a plurality of through holes 9h extending therethrough in the vertical direction are disposed at equal intervals in a peripheral direction. The piston lower chamber 9L and the piston upper chamber 9U communicate with each other via the through holes 9h. Note that each of the through holes 9h is provided with a check valve, and the ERF 8 is configured to flow in one direction in each of the through holes.

An upper end portion of the inner cylinder 4 is closed by the upper end plate 2a of the base shell 2 via the oil seal 7. In a lower end portion of the inner cylinder 4, there is a body 10. In the body 10, through holes 10h are provided in the same manner as in the piston 9, and communication with the piston chamber 9L is provided via the through holes 10h.

In the vicinity of an upper end of the inner cylinder 4, a plurality of horizontal holes 5 extending therethrough in a radial direction are disposed at equal intervals in the peripheral direction. An upper end portion of the outer cylinder 3 is closed by the upper end plate 2a of the base shell 2 via the oil seal 7 in the same manner as in the inner cylinder 4, while a lower end portion of the outer cylinder 3 is open. The horizontal holes 5 provide communication between the piston upper chamber 9U defined by the inside of the inner cylinder 4 and a rod-shaped portion of the rod 6 and a flow path 22 defined by the inside of the outer cylinder 3 and the outside of the inner cylinder 4. The flow path 22 has a lower end portion communicating with a flow path 23 defined by the inside of the base shell 2 and the outside of the outer cylinder 3 and with a flow path 24 between the body 10 and a bottom plate of the base shell 2. The ERF 8 fills an inner part of the base shell 2, while an inert gas 13 fills an upper part of a space between the inside of the base shell 2 and the outside of the outer cylinder 3.

When the vehicle drives on an uneven running surface, with the vibration of the vehicle, the rod 6 extends/contracts in the vertical direction along the inner cylinder 4. When the rod 6 extends/contracts along the inner cylinder 4, respective capacities of the piston lower chamber 9L and the piston upper chamber 9U change.

A vehicle body (not shown) is provided with an acceleration sensor 25. The acceleration sensor 25 detects an acceleration of the vehicle body and outputs a detection signal to the control device 11. The control device 11 determines, based on the signal from the acceleration sensor 25 or the like, a voltage to be applied to the electro-rheological fluid body 8.

The control device 11 arithmetically determines, based on the detected acceleration, a voltage for generating a required damping force and applies the voltage between the electrodes based on a result of the arithmetic determination to achieve the electro-rheological effect. When the voltage is applied by the control device 11, the viscosity of the ERF 8 changes depending on the voltage. The control device 11 adjusts, based on the acceleration, the voltage to be applied to control the damping force of the cylinder device 1 and improve ride comfort of the vehicle.

The cylinder device in the present invention uses the ERF 8 in the present invention described above, and therefore it is possible to obtain the large ER effect, while reducing the current density. Since there is no need to apply a high voltage as applied in Patent Literature 1 described above to obtain the large ER effect, it is possible to simplify a power source device and save energy or downsize the cylinder device.

### EXAMPLES

A specific description will be given below by showing Examples and Comparative Examples, but the present invention is by no means limited by Examples shown below.

### (a) Production of ERF in Example 1

LiCl, ZnCl₂, polyether-based polyol, an emulsifier, and silicone oil were mixed and emulsified using a homogenizer. Then, two types of hardening agents, i.e., HDI and TDI were used in the order shown above to harden an polyol emulsion in two steps, and an ERF composition in which polyurethane particles (ERF particles) each including the first layer and a second layer were dispersed in the silicon oil was obtained. Note that an amount of the TDI added to serve as the hardening agent which forms the first layer was set to provide 20 mol % based on a total addition amount of the hardening agents (HDI and TDI).

An average particle diameter of the polyurethane particles was 4.2 μm, a particle density thereof was 49.3 mass %, an amount of moisture content thereof was 360 ppm, and a viscosity of the silicone oil was 5 cP.

The respective glass transition temperatures of the polyurethane particles individually synthesized using the two types of hardening agents used for synthesis were measured. The measurement used a differential scanning calorimetry (DSC). The first layer using the TDI had T_{g} of −31° C., while the second layer using the HDI had T_{g} of −49.3° C. Thus, it was proved that, in the ERF mentioned above, T_{g} of the first layer was higher than T_{g} of the second layer.

To verify that, as T_{g} is higher, the ion conductivity is lower, the respective current densities of the ERF including the particles using the HDI and the ERF including the particles using the TDI at ° C. were measured, and the ion conductivities (synonymous to electric conductivities on the assumption that all the carries are ions) were calculated on the assumption that all the carriers in a current were ions. The calculated ion conductivities were 51.3 μA/cm² (1.0×10⁻⁹ S/cm) and 3.5 μA/cm² (2.3×10⁻¹¹ S/cm), and it was confirmed that the magnitude of the ion conductivity and the magnitude of the glass transition temperature had correlation therebetween. When other hardening agents were used also, the same tendency was obtained and, for the polyurethane in the present invention also, it was confirmed that T_{g} and the ion conductivity had correlation therebetween.

Aromatic concentrations inside and outside the synthesized ERF particles were measured by Raman spectroscopic analysis performed on a surface and a cross section thereof. Specifically, the aromatic concentrations were calculated from aromatic peak areas with respect to urethane bonds and compared to each other. In the ERF described in Example 1, the aromatic concentration in the first layer was 1.6 times the aromatic concentration in the second layer. In Table 1 described later, a configuration of each of the ERF particles, the glass transition temperatures T_{g} in the first and second layers, a ratio therebetween, and an aromatic concentration ratio between the first and second layers in Example 1 are shown.

### (b) Production of ERF in Example 2

The ERF was produced in the same manner as in Example 1 except that the TDI in the first layer in Example 1 was changed to MDI. An average particle diameter of the polyurethane particles was 4 μm, a particle density thereof was 49 mass %, and an amount of moisture content was 310 ppm. The glass transition temperature T_{g} in the first layer was −27.2° C., while the glass transition temperature T_{g} in the second layer was −49.3° C. The aromatic concentration in the first layer was 1.8 times the aromatic concentration in the second layer. A configuration of each of the ERF particles, the glass transition temperatures T_{g} in the first and second layers, a ratio therebetween, and an aromatic concentration ratio between the first and second layers in Example 2 are also shown in Table 1.

### (c) Production of ERF in Example 3

The ERF was produced in the same manner as in Example 1 except that the hardening agent TDI in Example 1 was changed to BPDI. An average particle diameter of the polyurethane particles was 4 μm, a particle density thereof was 49 mass %, and an amount of moisture content was 300 ppm. The glass transition temperature T_{g} in the first layer was −25.1° C., while the glass transition temperature T_{g} in the second layer was −49.3° C. An aromatic concentration in the first layer was 1.9 times an aromatic concentration in the second layer. A configuration of each of the ERF particles, the glass transition temperatures T_{g} in the first and second layers, a ratio therebetween, and an aromatic concentration ratio between the first and second layers in Example 3 are also shown in Table 1.

### (d) Production of ERF in Example 4

The ERF was produced in the same manner as in Example 1 except that the HDI used to produce the second layer in Example 1 was changed to XDI and the TDI used to produce the first layer in Example 1 was changed to MDI. An average particle diameter of the polyurethane particles was 4 μm, a particle density thereof was 49.2 mass %, and an amount of moisture content was 280 ppm. The glass transition temperature T_{g} in the first layer was −27.2° C., while the glass transition temperature T_{g} in the second layer was −46° C. An aromatic concentration in the first layer was 1.5 times an aromatic concentration in the second layer. A configuration of each of the ERF particles, the glass transition temperatures T_{g} in the first and second layers, a ratio therebetween, and an aromatic concentration ratio between the first and second layers in Example 4 are also shown in Table 1.

### (e) Production of ERF in Example 5

The ERF was produced in the same manner as in Example 4 except that the MDI used to produce the second layer in Example 4 was changed to pMDI. An average particle diameter of the polyurethane particles was 4.1 μm, a particle density thereof was 49.1 mass %, and an amount of moisture content was 300 ppm. The glass transition temperature T_{g} in the first layer was −21.3° C., while the glass transition temperature T_{g} in the second layer was −46° C. An aromatic concentration in the first layer was 1.7 times an aromatic concentration in the second layer. A configuration of each of the ERF particles, the glass transition temperatures T_{g} in the first and second layers, a ratio therebetween, and an aromatic concentration ratio between the first and second layers in Example 5 are also shown in Table 1.

### (f) Production of ERF in Example 6

The ERF was produced in the same manner as in Example 4 except that the MDI used to produce the second layer in Example 4 was changed to BPDI. An average particle diameter of the polyurethane particles was 3.9 μm, a particle density thereof was 49.5 mass %, and an amount of moisture content was 360 ppm. The glass transition temperature T_{g} in the first layer was −25.1° C., while the glass transition temperature T_{g} in the second layer was −46° C. An aromatic concentration in the first layer was 1.6 times an aromatic concentration in the second layer. A configuration of each of the ERF particles, the glass transition temperatures T_{g} in the first and second layers, a ratio therebetween, and an aromatic concentration ratio between the first and second layers in Example 6 are also shown in Table 1.

### (g) Production of ERF in Example 7

The ERF was produced in the same manner as in Example 1 except that the HDI used to produce the second layer in Example 1 was changed to TDI and the TDI used to produce the first layer in Example 1 was changed to MDI. An average particle diameter of the polyurethane particles was 3.9 μm, a particle density thereof was 49.6 mass %, and an amount of moisture content was 280 ppm. The glass transition temperature T_{g} in the first layer was −27.2° C., while the glass transition temperature T_{g} in the second layer was −31° C. An aromatic concentration in the first layer was 1.5 times an aromatic concentration in the second layer. A configuration of each of the ERF particles, the glass transition temperatures T_{g} in the first and second layers, a ratio therebetween, and an aromatic concentration ratio between the first and second layers in Example 7 are also shown in Table 1.

### (h) Production of ERF in Eighth Example

The ERF was produced in the same manner as in Example 7 except that the MDI used to produce the second layer in Example 7 was changed to pMDI. An average particle diameter of the polyurethane particles was 4.0 μm, a particle density thereof was 49.0 mass %, and an amount of moisture content was 250 ppm. The glass transition temperature T_{g} in the first layer was −21.3° C., while the glass transition temperature T_{g} in the second layer was −31° C. An aromatic concentration in the first layer was 1.7 times an aromatic concentration in the second layer. A configuration of each of the ERF particles, the glass transition temperatures T_{g} in the first and second layers, a ratio therebetween, and an aromatic concentration ratio between the first and second layers in Example 7 are also shown in Table 1.

### (i) Production of ERF in Examples 9 to 13 and Comparative Example 6

The ERF was produced in the same manner as in Example 7 except that the MDI used to produce the first layer in Example 7 was changed to BPDI. An amount of the BPDI in Example 9 was set to provide 5.9% as a ratio of the hardening agent required to be added to form the first layer (outer layer) to all the hardening agents, and the amounts of the BPDI in Examples 10, 11, 12, and 13 were set progressively larger in this order to 11.1%, 20%, 27.3%, and 33.3%. Meanwhile, the amount of the BPDI in Comparative Example 6 was set to provide 3% as a ratio of the hardening agent required to be added to form the first layer (outer layer) to all the hardening agents, and the ERF was produced by the same method. A configuration of each of the ERF particles, the glass transition temperatures T_{g} in the first and second layers, a ratio therebetween, and an aromatic concentration ratio between the first and second layers in Examples 9 to 13 and Comparative example 6 are also shown in Table 1.

### (j) Production of ERF in Example 14

The ERF was produced in the same manner as in Example 7 except that the polyether-based polyol in the first and second layers in Example 7 was changed to polycarbonate-based polyol. An average particle diameter of the polyurethane particles was 4 μm, a particle density thereof was 49 mass %, and an amount of moisture content was 350 ppm. The glass transition temperature T_{g} in the first layer was −25.8° C., while the glass transition temperature T_{g} in the second layer was −30.1° C. An aromatic concentration in the first layer was 1.5 times an aromatic concentration in the second layer. A configuration of each of the ERF particles, the glass transition temperatures T_{g} in the first and second layers, a ratio therebetween, and an aromatic concentration ratio between the first and second layers in Example 14 are also shown in Table 2.

### (k) Production of ERF in Example 15

In phenol, LiCl was dissolved and emulsified using a homogenizer, followed by addition of formaldehyde, to synthesize phenol resin particles having LiCl included therein. The particles mentioned above were reacted with ETERNACOLL OXBP as oxetane monomer manufactured by Ube Industries, Ltd. in the presence of ammonium salt in dimethyl sulfoxide. As a result, a hard reaction product of phenol with oxetane was formed on surfaces of the particles. This is a type of encapsulation technique. Note that an amount of the oxetane monomer to be added to phenol was set to provide 10 mass %. Thus, ERF particles each having a double-layered structure including a composite material layer of phenol and oxetane as a first layer and a phenol resin in a second layer were produced. The ERF particles were dispersed in silicone oil to provide the ERF in Example 15. Note that a viscosity of the silicone oil was 5 cP. An average particle diameter of the particles was 4.7 μm, a particle density thereof was 50.4 mass %, and an amount of moisture content was 360 ppm. A configuration of each of the ERF particles, the glass transition temperatures T_{g} in the first and second layers, a ratio therebetween, and an aromatic concentration ratio between the first and second layers in Example 14 are also shown in Table 2.

### (l) Production of ERF in Example 16

ER particles each having a double-layered structure made of two different materials were formed by coating polyurethane particles including LiCl by a hetero-coagulation method (Layer-by-Layer method) using TECHPOLYMER as acrylic resin particles manufactured by Sekisui Plastics Co., Ltd. Note that the ERF in Example 16 was produced in the same manner as in Example 15 except that an amount of the acrylic resin particles to be added to the polyurethane particles was set to provide 15 mass %. A viscosity of the silicone oil was 5 cP, an average particle diameter of the particles was 4.9 μm, a particle density thereof was 50.7 mass %, and an amount of moisture content was 360 ppm. A configuration of each of the ERF particles, the glass transition temperatures T_{g} in the first and second layers, and a ratio therebetween in Example 16 are also shown in Table 2.

### (m) Production of ERF in Example 17

ER particles each having a double-layered structure made of two different materials were formed by coating polyurethane particles including LiCl with silica by a sol-gel method using tetraethyl orthosilicate. Note that an amount of the tetraethyl orthosilicate to be added to serve as a raw material which results in silica and forms the first layer to the polyurethane particles was set to provide 10 mass %. The ERF in Embodiment 17 was produced in otherwise the same manner as in Embodiment 15. A viscosity of the silicone oil was 5 cP, an average particle diameter of the particles was 4.5 μm, a particle density thereof was 50.5 mass %, and an amount of moisture content was 360 ppm. A configuration of each of the ERF particles, the glass transition temperatures T_{g} in the first and second layers, and a ratio therebetween in Example 16 are also shown in Table 2.

### (n) Production of ERF in Comparative Example 1

The ERF was produced in the same manner as in Example 1 except that the TDI used as the hardening agent to produce the first layer in Example 1 was changed to HDI. Each of the glass transition temperatures T_{g} in the first and second layers was −49.3° C., and an aromatic concentration in the first layer was 1 times an aromatic concentration in the second layer. There was no physical property difference between the first and the second layer of each of the ERF particles. A configuration of each of the ERF particles, the glass transition temperatures T_{g} in the first and second layers, a ratio therebetween, and an aromatic concentration ratio between the first and second layers in Comparative Example 1 are also shown in Table 2.

### (o) Production of ERF in Comparative Example 2

The ERF was produced in the same manner as in Example 1 except that each of the hardening agents used to produce the first and second layers in Example 1 was changed to XDI. Each of the glass transition temperatures T_{g} in the first and second layers was −46° C., and an aromatic concentration in the first layer was 1 times an aromatic concentration in the second layer. A configuration of each of the ERF particles, the glass transition temperatures T_{g} in the first and second layers, a ratio therebetween, and an aromatic concentration ratio between the first and second layers in Comparative Example 2 are also shown in Table 2.

### (p) Production of ERF in Comparative Example 3

The ERF was produced in the same manner as in Example 1 except that an emersion of the polyether-based polyol was hardened sequentially using two types of hardening agents, i.e., XDI and HDI. The glass transition temperature T_{g} in the first layer was −49.3° C., while the glass transition temperature T_{g} in the second layer was −46° C. Due to the relationship between T_{g} in the two layers, in Comparative Example 3, an ion conductivity in the second layer was lower than that in the first layer. A configuration of each of the ERF particles, the glass transition temperatures T_{g} in the first and second layers, a ratio therebetween, and an aromatic concentration ratio between the first and second layers in Comparative Example 3 are also shown in Table 2.

### (q) Production of ERF in Comparative Example 4

The ERF was produced in the same manner as in Example 1 except that each of the hardening agents used to produce the first and second layers in Example 1 was changed to TDI. Each of the glass transition temperatures T_{g} in the first and second layers was −31° C., and an aromatic concentration in the first layer was 1 times an aromatic concentration in the second layer. A configuration of each of the ERF particles, the glass transition temperatures T_{g} in the first and second layers, a ratio therebetween, and an aromatic concentration ratio between the first and second layers in Comparative Example 2 are also shown in Table 2.

### (r) Production of ERF in Comparative Example 5

The ERF was produced in the same manner as in Example 1 except that an emersion of the polyether-based polyol was hardened sequentially using two types of hardening agents, i.e., TDI and HDI. The glass transition temperature T_{g} in the first layer was −49.3° C., while the glass transition temperature T_{g} in the second layer was −31° C. Due to the relationship between Tg in the two layers, in Comparative Example 3, an ion conductivity in the first layer is lower than that in the second layer. A configuration of each of the ERF particles, the glass transition temperatures T_{g} in the first and second layers, a ratio therebetween, and an aromatic concentration ratio between the first and second layers in Comparative Example 5 are also shown in Table 2.

### (s) Production of ERF in Comparative Example 7

A fluid dispersion obtained by dispersing phenol resin particles not treated with the oxetane monomer and the onium salt in Embodiment 15 in silicone oil was used as an electro-rheological fluid. The ERF in Comparative Example 6 was produced in otherwise the same manner as in Example 15. A configuration of each of the ERF particles, the glass transition temperatures T_{g} in the first and second layers, a ratio therebetween, and an aromatic concentration ratio between the first and second layers in Comparative Example 6 are also shown in Table 2.

### (t) Evaluation of Electro-Rheological Effect (ER Effect), Current Density, and Shacking Test

Using a rheometer (produced by Anton Paar GmbH, Model: MCR 502), respective electro-rheological effects and current densities in individual specimens produced in Embodiments 1 to 17 and Comparative Examples 1 to 7 were measured by a rotational viscometer method. Using flat plates each having a diameter of 25 mm, the ER effects (Index: Yield Stress) were measured under conditions under which a measurement temperature range was 20° C. and an applied electric field intensity was 5 kV/ram. Values were calculated on the assumption that a shear rate was ⅔×(ω×R)/H and a shear stress was 4/3×M/(π×R3) in the present rheometer. Note that ω represents an angular velocity, R represents a plate radius, H represents a plate-to-plate distance, and M represents a motor torque.

Meanwhile, the ERF in each of Examples 1 to 8 and Comparative Examples 1 to 4 was enclosed in the cylinder device illustrated in FIG. 1, a shaking test was performed, and damping forces were evaluated. Test conditions were such that a piston amplitude was 50 mm, a piston speed was 0.3 m/s, a temperature was 20° C., and an applied electric field intensity was 5 kV/ram.

Compositions of the ERF particles in Examples 1 to 7 and Comparative Examples 1 to 7, the ER effects thereof, the current densities thereof, and a damping force ratio (values based on the damping force in Comparative Example 1) thereamong are shown in Table 1 and Table 2 described later.

TABLE 1

| | Configuration of ERF Particle | | | | | | | | |
|---|---|---|---|---|---|---|---|---|---|
| | | | | | Glass | | | | |
| | First Layer (Outer Layer) | | Second Layer (Inner Layer) | | Transition | | | | |
| | | Glass | | Glass | Temperature | | Evaluation Result | | |
| | Polyol/ | Transition | Polyol/ | Transition | Ratio between | Aromatic | ER | Current | Damping |
| | Hardening | Temperature | Hardening | Temperature | First and | Concentration | Effect/ | Density/ | Force |
| | Agent | T_{g}(° C.) | Agent | T_{g}(° C.) | Second Layers | Ratio | kPa | μA/cm² | Ratio |
| Example 1 | Polyether-Based | −31 | Polyether- | −49.3 | 0.63 | 1.6 | 2.3 | 3.5 | 1.3 |
| | Polyol/TDI | | Based | | | | | | |
| | (Ratio of Added | | Polyol/HDI | | | | | | |
| | TDI:20 mol %) | | | | | | | | |
| Example 2 | Polyether-Based | −27.2 | | | 0.55 | 1.8 | 2.6 | 3 | 1.7 |
| | Polyol/MDI | | | | | | | | |
| | (Ratio of Added | | | | | | | | |
| | MDI:20 mol %) | | | | | | | | |
| Example 3 | Polyether-Based | −25.1 | | | 0.51 | 1.9 | 2.7 | 2.3 | 1.8 |
| | Polyol/BPDI | | | | | | | | |
| | (Ratio of Added | | | | | | | | |
| | BPDI:20 mol %) | | | | | | | | |
| Example 4 | Polyether-Based | −27.2 | Polyether- | −46 | 0.59 | 1.5 | 2.6 | 3.3 | 1.7 |
| | Polyol/MDI | | Based | | | | | | |
| | (Ratio of Added | | Polyol/XDI | | | | | | |
| | MDI:20 mol %) | | | | | | | | |
| Example 5 | Polyether-Based | −21.3 | | | 0.46 | 1.7 | 2.7 | 3.1 | 1.8 |
| | Polyol/Polymeric | | | | | | | | |
| | MDI (Ratio of | | | | | | | | |
| | Added Polymeric | | | | | | | | |
| | MDI:20 mol %) | | | | | | | | |
| Example 6 | Polyether-Based | −25.1 | | | 0.55 | 1.6 | 2.9 | 2 | 1.9 |
| | Polyol/BPDI | | | | | | | | |
| | (Ratio of Added | | | | | | | | |
| | BPDI:20 mol %) | | | | | | | | |
| Example 7 | Polyether-Based | −27.2 | Polyether- | −31 | 0.88 | 1.5 | 3.9 | 3.6 | 2.6 |
| | Polyol/MDI | | Based | | | | | | |
| | (Ratio of Added | | Polyol/TDI | | | | | | |
| | MDI:20 mol %) | | | | | | | | |
| Example 8 | Polyether-Based | −21.3 | | | 0.69 | 1.7 | 3.5 | 3.3 | 2.4 |
| | Polyol/Polymeric | | | | | | | | |
| | MDI (Ratio of | | | | | | | | |
| | Added Polymeric | | | | | | | | |
| | MDI:20 mol %) | | | | | | | | |
| Example 9 | Polyether-Based | −30.2 | | | 0.97 | 1.1 | 5.2 | 3.9 | 1.6 |
| | Polyol/BPDI | | | | | | | | |
| | (Ratio of Added | | | | | | | | |
| | BPDI:5.9 mol %) | | | | | | | | |
| Example 10 | Polyether-Based | −27.6 | | | 0.89 | 1.3 | 5 | 3.2 | 1.9 |
| | Polyol/BPDI | | | | | | | | |
| | (Ratio of Added | | | | | | | | |
| | BPDI:11.1 mol %) | | | | | | | | |
| Example 11 | Polyether-Based | −25.1 | | | 0.81 | 1.6 | 4.8 | 2.8 | 2.9 |
| | Polyol/BPDI | | | | | | | | |
| | (Ratio of Added | | | | | | | | |
| | BPDI:20 mol %) | | | | | | | | |
| Example 12 | Polyether-Based | −23.7 | | | 0.76 | 1.8 | 4.8 | 2.8 | 2.1 |
| | Polyol/BPDI | | | | | | | | |
| | (Ratio of Added | | | | | | | | |
| | BPDI:27.3 mol %) | | | | | | | | |
| Example 13 | Polyether-Based | −21.3 | | | 0.69 | 2 | 3.1 | 0.5 | 1.1 |
| | Polyol/BPDI | | | | | | | | |
| | (Ratio of Added | | | | | | | | |
| | BPDI:33.3 mol %) | | | | | | | | |

TABLE 2

| | Configuration of ERF Particle | | | | | | | | |
|---|---|---|---|---|---|---|---|---|---|
| | | | | | Glass | | | | |
| | First Layer (Outer Layer) | | Second Layer (Inner Layer) | | Transition | | | | |
| | | Glass | | Glass | Temperature | | Evaluation Result | | |
| | Polyol/ | Transition | Polyol/ | Transition | Ratio between | Aromatic | ER | Current | Damping |
| | Hardening | Temperature | Hardening | Temperature | First and | Concentration | Effect/ | Density/ | Force |
| | Agent | T_{g}(° C.) | Agent | T_{g}(° C.) | Second Layers | Ratio | kPa | μA/ cm² | Ratio |
| Example 14 | Polycarbonate-Based | −25.8 | Polycarbonate- | −30.1 | 0.9 | 1.5 | 3.7 | 3.9 | 1.4 |
| | Polyol/MDI | | Based | | | | | | |
| | (Ratio of Added | | Polyol/TDI | | | | | | |
| | MDI:20 mol %) | | | | | | | | |
| Example 15 | Phenol/Oxetane | 82.1 | Phenol Resin | 79.3 | 1 | — | 2.5 | 1 | 1.5 |
| | Composite Material | | | | | | | | |
| | (Addition Rate of | | | | | | | | |
| | Oxetane:10 mass %) | | | | | | | | |
| Example 16 | Acrylic Resin | 0 or more | Polyurethane | −31 | — | — | 2.3 | 1 | 1.5 |
| | (Addition Rate | | (Polyether-Based | | | | | | |
| | of Acrylic Resin | | Polyol/TDI) | | | | | | |
| | Particles:15 mass %) | | | | | | | | |
| Example 17 | Silica (Addition | — | | | — | — | 2.5 | 0.8 | 1.7 |
| | Rate of Tetraethyl | | | | | | | | |
| | Orthosilicate:10 | | | | | | | | |
| | mass %) | | | | | | | | |
| Comparative | Polyether-Based | −49.3 | Polyether-Based | −49.3 | 1 | 1 | 1.5 | 51.3 | 1 |
| Example 1 | Polyol/HDI | | Polyol/HDI | | | | | | |
| Comparative | Polyether-Based | −46 | Polyether-Based | −46 | 1 | 1 | 1.3 | 17.6 | 0.9 |
| Example 2 | Polyol/XDI | | Polyol/XDI | | | | | | |
| Comparative | Polyether-Based | −49.3 | | | 1.1 | 0.6 | 0.9 | 34.1 | 0.6 |
| Example 3 | Polyol/HDI | | | | | | | | |
| | (Ratio of Added | | | | | | | | |
| | HDI:20 mol %) | | | | | | | | |
| Comparative | Polyether-Based | −31 | Polyether-Based | −31 | 1 | 1 | 1.6 | 4.8 | 1.1 |
| Example 4 | Polyol/TDI | | Polyol/TDI | | | | | | |
| Comparative | Polyether-Based | −49.3 | | | 1.6 | 0.6 | 0.5 | 53.7 | 0.3 |
| Example 5 | Polyol/HDI | | | | | | | | |
| | (Ratio of Added | | | | | | | | |
| | HDI:20 mol %) | | | | | | | | |
| Comparative | Polyether-Based | −31.5 | | | 1 | 0.9 | 1.6 | 7.6 | 1.1 |
| Example 6 | Polyol/BPDI | | | | | | | | |
| | (Ratio of Added | | | | | | | | |
| | BPDI:3 mol %) | | | | | | | | |

| | | | | | | | | |
|---|---|---|---|---|---|---|---|---|
| Comparative | Absent | Phenol Resin | 79.3 | — | — | 2.2 | 1.2 | 1.5 |
| Example 7 | | | | | | | | |

It is inferred that, in Table 1, the ER particle in which the glass transition temperature Tg in the first layer is lower than the glass transition temperature Tg in the second layer, i.e., is less than 1 has the ion conductivity in the first layer which is lower than the ion conductivity in the second layer, and has a configuration falling within the scope of the present invention. Likewise, it is inferred that the ER particle in which the aromatic concentration ratio between the first layer and the second layer is less than 1 has the ion conductivity in the first layer which is lower than the ion conductivity in the second layer, and has a configuration falling within the scope of the present invention.

Meanwhile, it is inferred that, in Comparative Example 1, Comparative Example 2, and Comparative Example 4, the compositions in the first and second layers are the same, the glass transition temperatures Tg in the first and second layers are equal, the aromatic concentration ratios between the first and second layers are equal, and the ion conductivities in the first and second layers are the same. It is also inferred that, in each of Comparative Examples 3 and 5, the glass transition temperature Tg in the first layer is lower than that in the second layer and the aromatic concentration ratio therebetween is also low, and therefore the ion conductivity in the first layer is higher than that in the second layer. It is considered that, in Comparative Example 6, the amount of the BPDI serving as the hardening agent forming the first layer was insufficient, Tg of polyurethane was low, and the effect of the present invention could not satisfactorily be obtained.

It is proved by Table 1 and 2 that each of Examples 1 to 16 of the present invention provided the electro-rheological fluid that can achieve the high electro-rheological effect and the low current density and is also useful in the cylinder device.

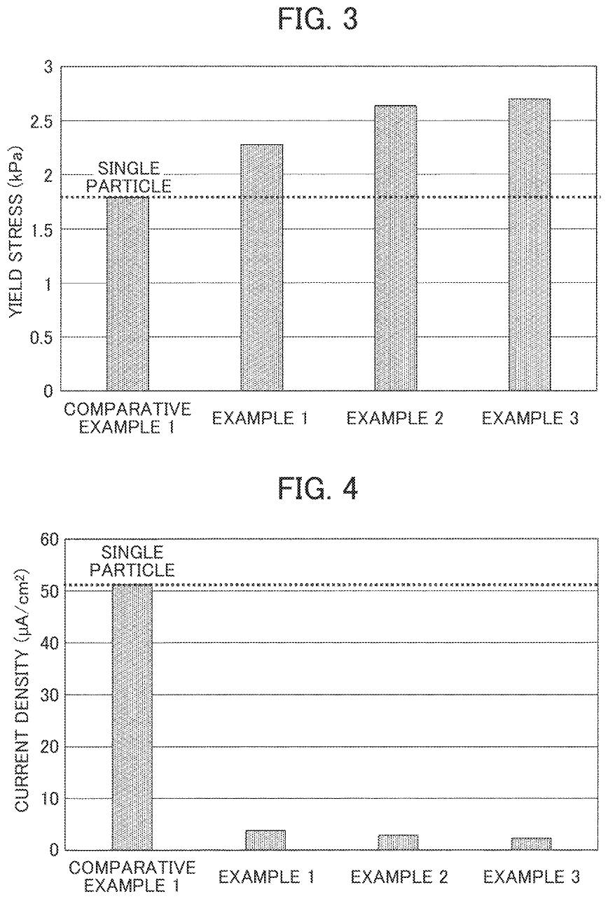

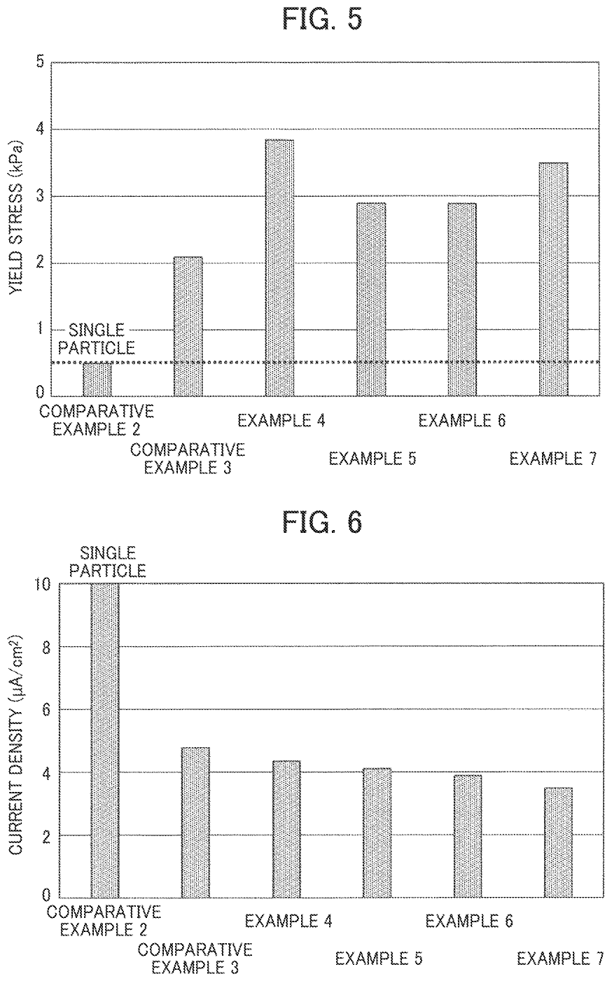

FIG. 3 is a graph comparatively illustrating the ER effects (yield stresses) in Examples 1 to 3 and Comparative Example 1. FIG. 4 is a graph comparatively illustrating the current densities in Examples 1 to 3 and Comparative Example 1. FIG. 5 is a graph comparatively illustrating the ER effects (yield stresses) in Examples 4 to 6 and Comparative Examples 2 and 3. FIG. 6 is a graph comparatively illustrating the current densities in Examples 4 to 6 and Comparative Examples 2 and 3. FIG. 7 is a graph comparatively illustrating the ER effects (yield densities) in Examples 7, 8, and 11 and Comparative Examples 4 and 5. FIG. 8 is a graph comparatively illustrating the current densities in Examples 7, 8, and 11 and Comparative Examples 4 and 5. As illustrated in FIGS. 3, 5, and 7, the yield stresses were higher in Examples 1 to 3, 4 to 6, 7, 8, and in which each of the ERF particles had a double-layered configuration including the first layer and the second layer than the yield stresses in Comparative Examples 1 to 5 in which each of the ERF particles had a single-layered configuration.

Meanwhile, the current densities were lower in Examples 1 to 3, 4 to 6, 7, 8, and 11 in which each of the ERF particles had the double-layered configuration including the first layer and the second layer than the current densities in Comparative Examples 1, 2, and 4 in which each of the ERF particles had the single-layered configuration. Accordingly, each of the ERF particles in which Tg is set higher in the outside thereof than in the inside of each of the polyurethane particles was able to achieve the higher electro-rheological effect and the lower current density than those achieved by the polyurethane particle having a uniform material composition. Meanwhile, each of the ERF particles in which Tg is set lower in the outside thereof than in the inside of the particle has the ER effect (yield stress) lower than that of a single particle and the current density higher than that of the single particle and therefore, even though the ERF particle is produced to have the double-layered configuration, Tg set higher outside the particle and the low ion conductivity each shown in the present invention are important.

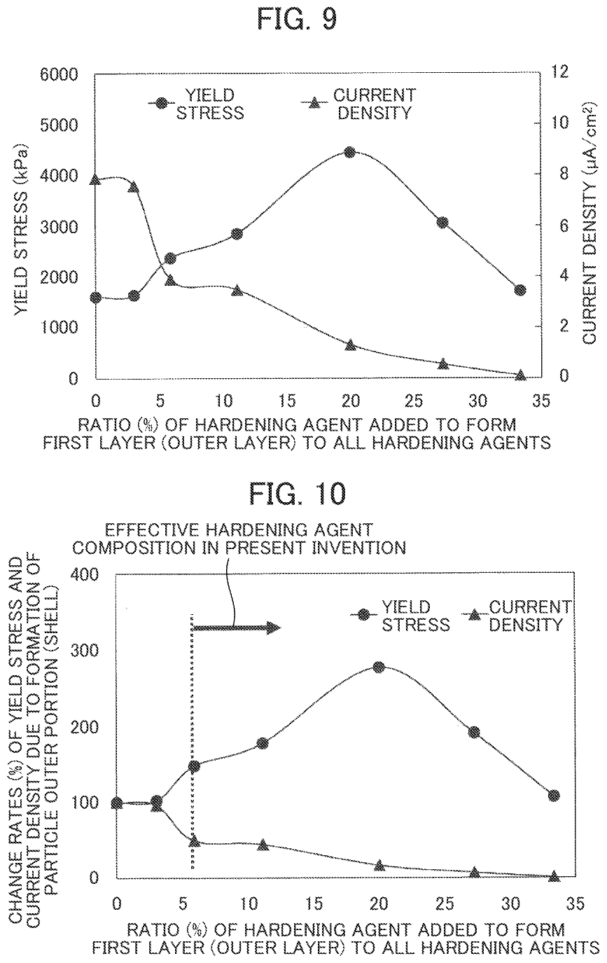

FIG. 9 is a graph illustrating relations among a ratio of the hardening agent added for the first layer to all the hardening agents, the yield stress in the first layer, and the current density in the first layer. FIG. 9 illustrates a plotting result in Examples 9 to 13, and Comparative Examples 4 and 6. As illustrated in FIG. 9, it can be seen that, by setting the ratio of the hardening agent added to form the first layer to 5.9% or more (a ratio of the additive in the second layer was less than 94%), the yield stress increased, while the current density significantly decreased.

FIG. 10 is a graph illustrating relations among the ratio of the hardening agent added for the first layer to all the hardening agents and change rates of the yield stress and the current density in the first layer. As illustrated in FIG. 10, it can be seen that, by setting the ratio of the hardening agent to be added for the first layer to 5.9% or more, it is possible to reduce the current density, while increasing the yield stress. In other words, as described above, the current density and the yield stress (ER effect) generally have the trade-off relationship therebetween but, by setting the ratio of the hardening agent to be added for the first layer to 5.9% or more, it is possible to dissolve the trade-off. Note that, since the ratio of the hardening agent added for the first layer which allows an effect of reducing the current density, while increasing the yield stress, to be obtained is equal to or lower than 33.3%, a ratio of the hardening agent to be added for the first layer which is most preferable for the effect of the present invention is 5.9% to 33.3%. However, even though the ratio of the hardening agent added for the first layer is equal to or more than 33.3%, when a reduction in current density is selectively large compared to a reduction in yield stress, the current density has selectively been reduced successfully, which falls within the scope of the present invention.

As has been described heretofore, it has been shown that, according to the present invention, it is possible to provide an electro-rheological fluid composition and a cylinder device which allow a large ER effect (yield stress) to be obtained, while reducing a current density.

Note that the present invention is not limited to Examples described above and includes various types of modifications. For example, Examples described above have been described in detail for the purpose of clear description of the present invention, and the present invention is not necessarily limited to those including all the configurations described in Examples. A part of a configuration of particular Example can be substituted with a configuration of another Example, and to a configuration of particular Example, a configuration of another Example can also be added. With regard to a part of a configuration of each Example, another configuration may be added, deleted, or substituted.

### LIST OF REFERENCE SIGNS

1 Cylinder device
2 Base shell
2a Upper end plate
Outer cylinder
3a Outer electrode
4 Inner cylinder (cylinder)
4a Inner electrode
5 Horizontal hole
6 Rod
7 Oil seal
8 Electric-rheological fluid
9 Piston
9L Piston lower chamber
9U Piston upper chamber
9h Through hole
10 Body
10h Through hole
11 Control device
13 Inert gas
20 Voltage application device
22, 23, 24 Flow path
25 Acceleration sensor
26 Moisture absorption mechanism
28 ERF particle
29 First layer (outer layer)
30 Second layer (inner layer)
31 Ion
32 Fluid

1. An electro-rheological fluid composition comprising:
a fluid; and
a particle having an ion conductivity, wherein
the particle having the ion conductivity has a first layer forming a surface of the particle and a second layer forming a part of the particle interior to the first layer, and
an ion conductivity of the first layer is lower than an ion conductivity of the second layer.

2. The electro-rheological fluid composition according to claim 1, wherein a glass transition temperature of the first layer is higher than a glass transition temperature of the second layer.

3. The electro-rheological fluid composition according to claim 1, wherein the particle having the ion conductivity is made of an organic material including an aromatic component, and a concentration of the aromatic component in the first layer is higher than a concentration of the aromatic component in the second layer.

4. The electro-rheological fluid composition according to claim 3, wherein the organic material is polyurethane having polyether-based polyol or polycarbonate-based polyol serving as a monomer.

5. The electro-rheological fluid composition according to claim 4, wherein isocyanate serving as the monomer of the polyurethane in the first layer is at least one selected from the group consisting of diphenylmethane diisocyanate, dimethylbiphenyl diisocyanate, and toluene diisocyanate, and isocyanate serving as the monomer of the polyurethane in the second layer is at least one selected from the group consisting of the toluene diisocyanate, hexamethylene diisocyanate, diphenylmethane diisocyanate, and xylene diisocyanate.

6. The electro-rheological fluid composition according to claim 1, wherein
the first layer is made of a composite material obtained by reacting epoxy or oxetane, and
the second layer is made of a phenol resin.

7. The electro-rheological fluid composition according to claim 1, wherein the first layer is made of an acrylic resin or silica, and the second layer is made of a polyurethane resin.

8. The electro-rheological fluid composition according to claim 1, wherein the particle includes a lithium ion.

9. The electro-rheological fluid composition according to claim 1, wherein a ratio of isocyanates added to serve as the monomer forming the first layer to all isocyanates is 5.9 mol % or more.

10. A cylinder device comprising:
an inner cylinder;
a piston movable along the inner cylinder;
an electro-rheological fluid composition filling a space between the inner cylinder and the piston; and
a voltage application device that applies a voltage to the electro-rheological fluid composition, wherein
the electro-rheological fluid composition includes a fluid and a particle having an ion conductivity,
the particle having the ion conductivity has a first layer forming a surface of the particle and a second layer forming a part of the particle interior to the first layer, and
an ion conductivity of the first layer is lower than an ion conductivity of the second layer.

11. The cylinder device according to claim 10, wherein a glass transition temperature of the first layer is higher than a glass transition temperature of the second layer.

12. The cylinder device according to claim 10, wherein the particle having the ion conductivity is made of an organic material including an aromatic component, and a concentration of the aromatic component in the first layer is higher than a concentration of the aromatic component in the second layer.

13. The cylinder device according to claim 12, wherein the organic material is polyurethane having polyether-based polyol or polycarbonate-based polyol serving as a monomer.

14. The cylinder device according to claim 13, wherein isocyanate serving as the monomer of the polyurethane in the first layer is at least one selected from the group consisting of diphenylmethane diisocyanate, dimethylbiphenyl diisocyanate, and toluene diisocyanate, and isocyanate serving as the monomer of the polyurethane in the second layer is at least one selected from the group consisting of the toluene diisocyanate, hexamethylene diisocyanate, diphenylmethane diisocyanate, and xylene diisocyanate.

15. The cylinder device according to claim 10, wherein
the first layer is made of a composite material obtained by reacting epoxy or oxetane, and
the second layer is made of a phenol resin.

16. The cylinder device according to claim 10, wherein the first layer is made of an acrylic resin or silica, and the second layer is made of a polyurethane resin.

17. The cylinder device according to claim 10, wherein the particle includes a lithium ion.

18. The cylinder device according to claim 10, wherein a ratio of isocyanates added to serve as the monomer forming the first layer to all isocyanates is 5.9 mass % or more.
